(19) United States
(12) Patent Application Publication
(10) Pub. No.: US 2020/0086433 A1
(43) Pub. Date: Mar. 19, 2020

(54) Method to Make Arc Welds with Mechanical Stirring by Solid Object in Molten Filler Metal

(71) Applicants: YuMing Zhang, Nicholasville, KY (US); Jerry Feng, Pasadena, CA (US)

(72) Inventors: YuMing Zhang, Nicholasville, KY (US); Jerry Feng, Pasadena, CA (US)

(21) Appl. No.: 16/133,692

(22) Filed: Sep. 17, 2018

(51) Int. Cl. B23K 37/06; B23K 9/30; B23K 9/32; B23K 35/36

(52) U.S. Cl. CPC B23K 37/06; B23K 35/3601; B23K 9/32; B23K 9/30

(57) ABSTRACT

A solid object is rotated in the central pool of molten metal that is formed by using an arc to melt a continuously fed metal wire and depositing the melted wire between the facing edges of two base metals to be joined. The stirring generated by the rotation in the pool moves hotter metal in the central region to its boundary adjacent to the facing edges. This stirring generated movement of molten metal is expected to better heat the facing edges so that the molten metal can better fuse with the facing edges. The stirring generated fluid flow within the molten pool also changes the solidification of the molten metal and the formation of the resultant grains.

### BACKGROUND

### Field of Invention

This invention relates to arc welding, and more particularly to gas metal arc welding, its variants, and modifications where a direct arc melting of filler metal is involved.

### Description of Related Art

Gas metal arc welding (GMAW), including its variants/modifications, is the most widely used process to join metals. This is in part due to its high efficiency in melting filler metal, needed to bridge base metals to join them together, as the filler metal is either an arc anode or cathode such that it can be melted directly by the arc [1].

However, the ability of GMAW in penetrating into the base metals, i.e., to melt into the depth direction, is relatively low. Increasing the depth being penetrated will also increase the melting of the base metals in the width direction, resulting in a large amount of base metals be melted causing large heat input, large distortions, and degrading in mechanical properties of the resultant welded structure. Directly using it to join thick metals, by penetrating through the entire base metals, is not a common practice.

A common strategy adopted to use GMAW to join relatively thick base metals together is to employ a groove between the facing edges of the base metals to be joined. The groove is made by removing part of the base metals on the facing edges in a way such that the gap between the facing edges varies, being the smallest at the deepest. As such, the groove allows the arc to easily access/heat any positions on the facing edges to effectively fuse the deposited molten filler metal with the edges. The base metals are joined together through a multiple pass process gradually but each pass uses an acceptable amount of the heat. The need for deep penetration is avoided but the expenses are substantial: much increased gap to be filled causes mandatory need of materials removing, materials wastes, much increased amount of filler materials, and much increased consumption of energy.

Another strategy adopted to use GMAW to join relatively thick base metals together is to employ a relatively narrow groove between the facing edges of the base metals to be joined. The use of a narrow groove affects the ability of the arc to easily access/heat the facing edges to effectively fuse the deposited molten filler metal with the edges. Narrow groove welding refers to a class of technologies that use specific techniques to allow the arc to better access the facing edges in a narrow groove. One of such technique is to use a special torch that allows the contact-tip from which the wire is fed out of the torch to rotate. In the meantime, the tip is shaped such that the wire points to different directions when the tip rotates. The arc that is established between the end of the wire and the work-piece thus aims to different directions. The facing edges will be pointed and heated by the arc during the rotation of the tip. However, the special equipment needed is typical expensive and its effective use requires extra caution. Unless the base metals are extremely thick, no narrow groove technologies would typically be used.

While the GMAW based methods to join relatively thick base metals are to fill gaps to avoid the needed for deep penetration, methods exist that directly penetrate into the base metals to join them together. This can be done by using high energy beam welding processes including plasma arc welding, laser welding, arc-laser hybrid welding, electron beam welding, etc. This can also be done by the friction stir welding (FSW) which directly rotates a solid tool in the solid base metals to soften them such that part of the base metals becomes flowable but not melted. All these methods have their own advantages and issues in comparison with the GMAW based method and should not be directly compared with the invention being disclosed.

### BRIEF SUMMARY OF THE INVENTION

Hence the objective of this invention is to provide an innovative method to use a GMAW based method to join relatively thick base metals together without using specific and expensive equipment that requires extra cautions nor a large groove that allows the arc to directly access the facing edges. The issues, as aforementioned, with the two strategies adopted to use a GMAW based method to join relatively thick base metals together can thus be avoided.

The key of this invention is to stir the liquid pool formed by the filler metal that has been melted by an arc during a GMAW process. Stirring the liquid pool is much easier than stirring a solid metal as in FSW. More specifically, in FSW, the stirring is to directly soften, if not melt, the base metals and the resultant soften metal is directly responsible for joining. The tool used to generate the stirring is in direct contact with the base metals to be joined. However, in this invention, the melted metal that is responsible for joining has been generated by arc melting, rather by the stirring. The tool that generates the stirring is not in direct contact with the solid base metals to be joined. The requirement on the tool and required forces thus differ from those for FSW. Because of the high efficiency associated with arcs in melting filler metals, the resultant speed would also differ. As such, the required hardness for the tool and required force will both decrease while the resultant tool life and welding speed will both increase in comparison with FSW.

Stirring in a liquid pool is an effective way to change the fluid flow in the pool. In a liquid pool with an uneven temperature distribution, a stirring helps the temperature to get evenly distributed, that is, the heat to flow from hotter portion to colder portion in the pool.

In a pool formed by melted filler metal between a groove between the facing edges of base metals which are much colder than the metal in the pool, the heat transfers quickly through the interfaces between the pool and base metals because of the large temperature gradients. If the temperature of the metal in the pool near the interfaces will tend to reduce rapidly. The layers of the base metals at the interfaces may not be melted because of the reduced temperature gradients. By stirring the pool, hotter liquid metal will replace the cooled liquid metal (which has transfer heat into the base metals) to increase the temperature gradients for more effective heat transfer to help melt the interface layers at the sides of the base metals.

Because of the stirring, a direct access of the arc to the facing edges may be eliminated such that the groove can thus be reduced. Further, the reduced groove also reduces the need the use of a large diameter tool to still generate stirring that is close to the facing edges. In turn, the reduced groove reduces the gap to be filled. All the benefits of narrow groove welding are achieved but using low-cost equipment without extra cautions.

### BRIEF DESCRIPTION OF THE DRAWINGS

FIG. 1 (Prior Art) shows the configuration of a conventional GMAW system. The filler metal is a continuously fed wire (100). The base metals (101) are faced each other and a groove (102) is formed by their facing edges (103), forming the work-piece (104). An arc (105) exists between the wire (100) and the work-piece (104). The wire (100) is melted by the arc (105), forming droplets (106) of liquid metal. Droplets (106) fills the groove (102). The facing edges (103) are heated by the arc (105) and droplets (106) such that the facing edges (103) are fused with the droplets (106) forming a pool of liquid metal from the droplets and base metals. Upon solidification of the metal in the pool, the facing edges are joined together.

FIG. 2 (Prior Art) shows the configuration of the conventional GMAW system from a side view. 200-206 are exactly the same as 100-106 in FIG. 1 but are depicted from a side view angle. The wire, carried by welding torch (not shown in the Figure), travels in the travel direction (207).

FIG. 3 (This Invention) and FIG. 4 (This Invention) show the configuration of this invention in comparison with the conventional GMAW from the front view and side view angles respectively. In FIG. 3, 300 is the filler metal; 301 the base metals; 302 the groove; 303 the facing edges; 304 the work-piece; 305 the arc; 306 the droplets; 307 the solid tool; and 308 the rotation direction. In FIG. 4, 400-406 are exactly the same as 300-306 in FIG. 3; while 407 is the travel direction, 408 the solid tool, 409 the rotation direction, 410 the distance behind the tool behind the wire, and 411 the filled groove. FIG. 3 shows that the groove has been changed to a square shape approximately; a solid tool is placed within the groove and rotating. FIG. 4 shows that a solid tool is added behind the wire and rotates within the pool of the liquid metal.

FIG. 5 (Prior Art) shows the configuration of a modified GMAW, double-electrode gas metal arc welding or DE-GMAW. 500-506 are the same as 100-106 in FIG. 1. A second wire (507) is added and a second arc (508) is formed between the main (original) wire (500) and the second wire (507). The main wire (500) and second wire (507) are melted by the main arc (505) and second arc (508) respectively. The droplets of the melted wires both fill the groove (502) but only the main arc directly heats the facing edges (503). The molten metal from the droplets and base metals forms the pool of liquid metal.

FIG. 6 (This Invention) shows the configuration of this invention as a modification of DE-GMAW. 600-609 are the same as 500-109 in FIG. 5; while 610 is the filled groove, 611 the solid tool, 612 the rotation direction, and 613 the distance behind the tool behind the main wire. The groove has been changed to a square shape approximately and the rotating solid object is within the groove (not shown in the Figure). A rotating solid object is added behind the wires and rotates within the pool of the liquid metal.

### EXPLANATION OF THE INVENTION

GMAW is relatively tolerant to manufacturing variations and can be easily mechanized/robotized at well acceptable cost and maintenance. It is often the first choice for many applications and is used as the benchmark process to determine if an alternative process would be needed.

For relatively thick base metals, if the facing edges form a relatively narrow square groove, the facing edges will be difficult to be heated/melted directly by the arc to fuse with the droplets from the molten filler metal. Hence, GMAW typically employs a relatively open groove to help the arc to directly heat and melt the facing edges. However, the cost is much increased gap to fill and much reduced productivity. In all cases, melting filler requires consumption of energy and use of a large gap is not preferred.

A narrow gap is preferred but the fusion of the facing edges must be assured preferably in well acceptable ways that permit easy operation, easy automation, and comfortable tolerance to possible variations in manufacturing conditions/fit-ups and operation precision. Also, the cost must be well acceptable and the productivity must not be compromised.

Existing narrow groove welding technologies and systems use mechanisms that permit the arc to be able to scan to the facing edges but the equipment is complex and its operation requires high precision.

In this invention, the GMAW process and its way to apply are not changed—the GMAW would still travels along the narrow groove. Of course, it is understood that the facing edges may not be well heated to fuse with the droplets from the melted filler metal because of the absence of the direct arc contact with them. To improve the heating on the facing edges, this invention thus discloses a method that applies a solid tool into the pool of the liquid metal formed by the melted filler metal between the facing edges. The solid tool is rotated at a high speed such that the heat quickly transfers with the pool. One consequence of such increased heat transfer is to replace the colder liquid metal in the pool near the facing edges by the hotter metal from other regions of the pool. The heating on the facing edges may be improved to better fuse with the metal from the melted filler wire to join the base metals together. The rotation of the solid tool can be easily realized by different ways including using a robot which can be programmed and adaptively adjusted such that the tool will always rotate at a desirable distance behind the wire along the narrow groove.

More specifically, the temperature of the liquid metal in the pool is uneven. The temperature of the liquid metal reduces from the pool center toward the pool border (near the facing edges). However, the temperature is all higher than the melting temperature and that of the facing edges if they have not been melted. There thus always be heat transfer from the liquid metal to the base metals. The temperature of the liquid metal at the border quickly reduces as the heat being transferred through the facing edges into the base metals. If there are no sufficient heat being transferred at relatively high speeds into the base metals, the facing edges will not be melted. By continuously stirring the pool, the cooler liquid metal at the border is continuously replaced by the hotter metal from other regions. More heat will be transferred through the facing edges into the base metals at higher speeds to help melt the facing edges. The average temperature of the liquid metal in the pool will also tend to reduce. As such, a strong stirring will help melt the facing edges, that have not been directly melted by the arc, to fuse the base metals with the melted filler metal and reduce the temperature of the liquid pool despite the use of a relatively narrow square groove.

An appropriate gap is needed. The gap should not be too large to unnecessarily increase the volume to be filled. If the gap is too small, the melted filler metal would not be able to be deposited within the groove. The minimal acceptable gap can be selected as the minimum to allow the majority of the melted filler metal to be deposited into the groove. The actual should be increased and the increase can be determined based on its influence on the productivity.

The diameter of the rotating solid tool should be appropriate to the gap and its variation. A closer distance of the tool with the facing edges will help transfer the heat from the pool center to melt the facing edges but the tool should not contact the facing edges during the rotation. To this end, the tool should be centered such that its distances to both facing edges are nominally the same and the diameter should be selected based on the gap and its variation. To be conservative, the diameter can be slightly reduced such that the tool would never contact the facing edges despite possible variations.

It is preferred that the width of the narrow groove formed between the facing edges be constant along the thickness direction by using a zero groove angle. A non-zero groove angle may also be used such that the gap gradually reduces along the thickness direction.

Joining the facing edges together may be completed in a single or multiple passes, as in existing narrow groove welding practices, depending on the thickness of the base metals to be joined. The position of the contact tip of the GMAW torch can be gradually elevated after each pass. The tool may be changed for a larger diameter each pass if the groove angle is not zero. The welding parameters, including the wire feed speed, torch position, arc voltage, and travel speed, and rotation parameters, including rotation speed and position (distance behind the wire), tool diameter, and tool submerging depth, may be changed for different passes.

The solid tool should be made by a material whose melting point is much higher than those of the filler metal and base metals. The tool can be appropriately shaped to enhance the heat transfer by its rotation in the pool of the melted filler metal to better heat and melt the facing edges.

### Examples of Wire Melting Processes

The role of the GMAW process in the present invention is to provide a convenient and highly efficient way to deposit melted filler metal to fill the groove between the facing edges to be joined. It is convenient because the automatic feed of the wire as the filler metal and is efficient because the wire is either an arc anode (in most GMAW applications) or arc cathode and can be directly heated by the arc. Such automatic feed of filler metal and arc based melting of filler metal can also be realized by other processes.

One example of such a process is the flux cored arc welding (FCAW) in which the filler metal is a flux cored wire which is also automatically fed and directly melted by an arc terminal. Another example of such a process is submerged arc welding (SAW) where the filler metal is an atomically fed wire which is also automatically fed and directly melted by an arc terminal but the liquid metal is shielded by fluxes rather than a shield gas. Since the flux will also be melted, the tool can also rotate in the groove which is now filled by the melted filler metal and melted flux.

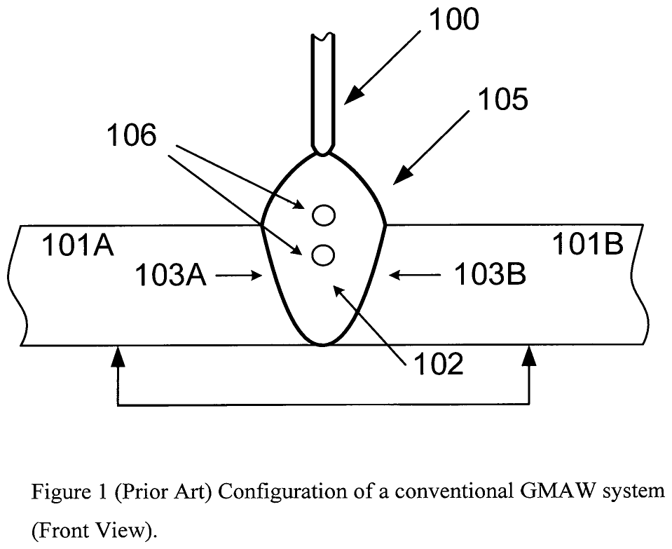

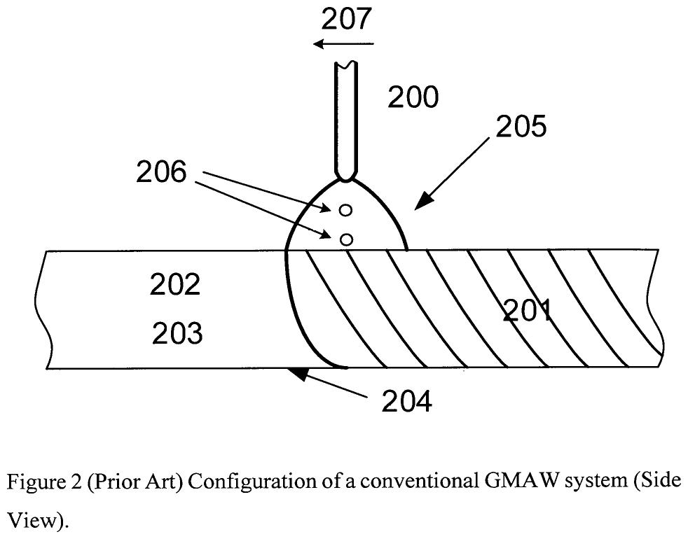

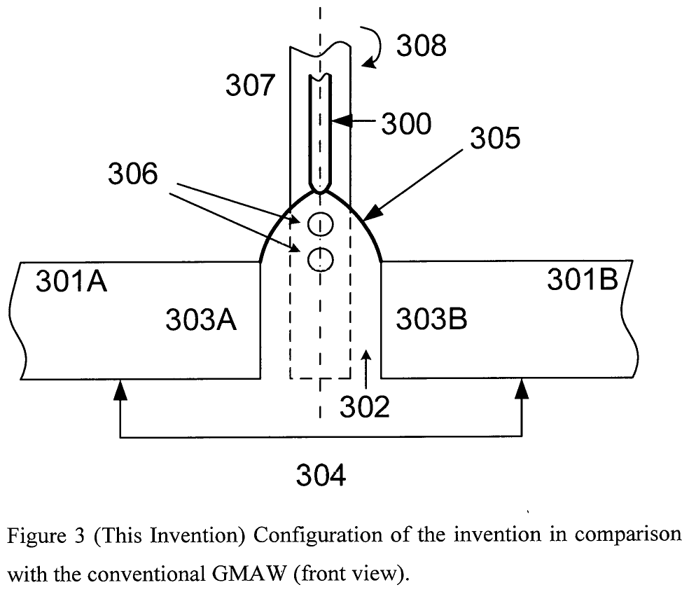

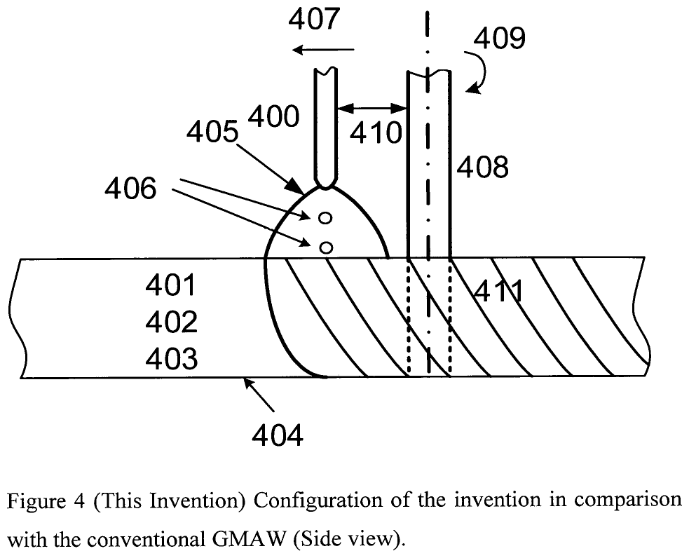

The wire is melted by the anode of the arc in most GMAW applications while it may also by the cathode in other applications. The melted metal can transfer into the groove in different mods including rotating, spray, globular, and short-circuiting and different methods may be used to help metal to transfer such as droplet detachment by laser and by wire retraction as in the cold metal transfer (CMT) process. The current waveform may also differ. In all such cases with different combinations of the polarity, metal transfer mode, detachment assistance and current waveform, the filler metal (wire) is automatically fed and arc based melting of the wire is involved. The role in providing a convenient and highly efficient way to deposit melted filler metal to fill the groove between the facing edges to be joined is unchanged. A different combination would provide an example for how the wire is fed and melted and can all be represented by FIG. 1.

The function in providing a convenient and highly efficient way to deposit melted filler metal to fill the groove between the facing edges to be joined may also be realized by a system which cannot be presented by FIG. 1 but the automatic feed of the filler and arc based melting of filler metal still stand.

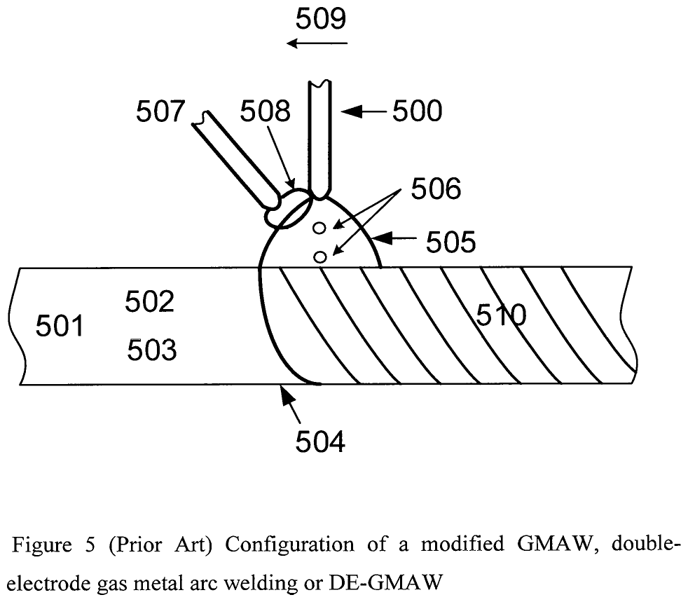

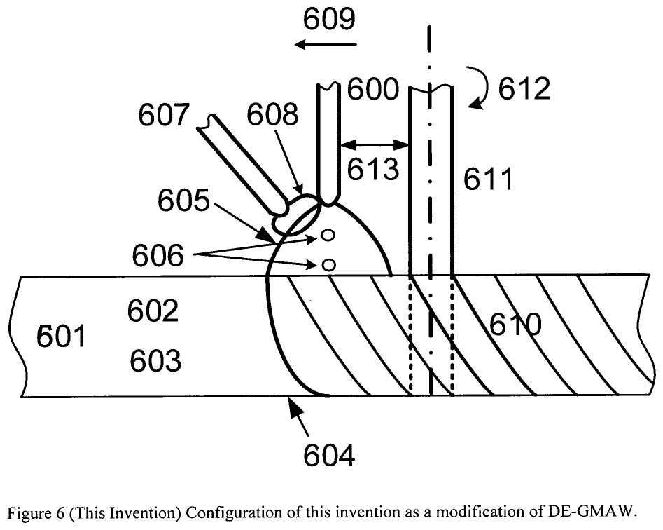

One of such examples is provided by the DE-GMAW process shown in FIG. 5. In this case, both wires are automatically fed and are both directly by respective arcs. The melted filler metals can also be automatically deposited into the groove. The solid tool may also stir within such a pool.

The use of the DE-GMAW allows to deposit the same amount of filler metal at reduced consumption of energy and reduced heat input into the welded structure. For conventional GMAW shown in FIG. 1, its common practice is to melt the wire by the arc anode in order to transfer the melted filler metal easily. The arc cathode is imposed on the base metals. For steels, the cathode voltage is approximately twice of that of the anode. Further, in conventional GMAW, the current at the wire (100) is exactly the same as that at the base metals (work-piece 104). The arc thus directly heats the base metals at twice power as directly heating the wire. For a given gap to be filled by depositing a required amount of filler metal, twice additional heat is applied directly into the base metals. If all the additional heat can be used to heat the entire facing edges evenly, such additional heat may effectively contribute to the joining of the base metals. If not, it may be wasted and should be reduced and this can be done by adding the second wire using a configuration shown in FIG. 5 where a second wire (507) is added and a second arc (508) is formed between the main (original) wire (500) and the second wire (507). The main wire (500) and second wire (507) are melted by the main arc (505) and second arc (508) respectively. Since the current at the main wire (500) is not changed, it is still heated at the same power. However, the current at the work-piece (5XX) is reduced, the additional heat directly imposed on the work-piece is reduced. The reduced amount of the current flows to the second wire (508) and the reduced amount of heat previously directly imposed on the work-piece is now imposed on the second wire (508). As such, the total use of energy keeps unchanged but more filler metal is melted. For the work-piece, the total heat input is unchanged but more melted filler metal is being deposited. To deposit the same amount of filer metal, the energy and heat input can be reduced. By stirring the pool of the melted filler metal, the facing edges may still be joined at such reduced consumption of energy and reduced heat input. The reduced heat input may help improve the microstructures of the resultant welds and heat-affected zones and reduce the distortion. If two wires of different compositions are used and the wire feed speeds are controlled accordingly, the metallurgy of the welds can be further controlled.

GMAW, including its variations such as FCAW and SAW and its modifications including the consumable DE-GMAW shown in FIG. 5 where a second wire is used, non-consumable DE-GMAW where the second wire in FIG. 5 is replaced by one or two non-consumable tungsten electrodes, and other variants as disclosed by Zhang et al. in a previous patent [XX], is just a class of examples for processes that can function to automatically feed filler metals and melt them efficiently by an arc. This function may also be provided by other processes such as the direct arc processes [XX, XX] where the arc is established fully between two wires and the work-piece is not directly imposed by the arc, and the cross arc processes [XX] where an arc is established between two wires and the work-piece is directly heated by a separate arc. In all such cases, the solid tool may still be applied into the pool of melted metal and generate a stirring in the pool to improve the heating and melting on the facing edges. For this point of view, this Invention may be enlarged to as a method to stir a pool of melted metal to improve the heating and melting of the facing edges despite the actual process that is used to melt and deposit the filler metal.

### Examples of Tool Material

To generate an effective stirring in the pool of melted filler metal to help improve the heating and melting on the facing edges, the tool must be a rigid solid. Since the tool stirs in a liquid pool, the force may not be a major concern in selecting the tool material while the melting point is.

An apparent example of the tool is a tungsten rod. The boiling point of iron is 2870 degree C. but the melting point of tungsten is 3400 degree C. A tungsten rod thus would never soften or melt in the pool of melted filler metal for joining steels. For other materials that are encountered in arc welding including aluminum, chromium, copper, gold, lead, magnesium, nickel, silver, and titanium, except for titanium, their boiling points are all below that of the iron. For titanium, it is 3290 degree C. which is still lower than the melting point of tungsten. Further, the actual temperature of the melted filler metal in majority of the pool must be much lower than that of their boiling point or the suitability of the practice would be subject to question. Hence, tungsten is a perfect material that can suit for being used as the tool material for majority of applications, if not all of them, of the disclosed invention.

Generating an effective stirring requires a rigid solid. If a wire is fed into the pool of the melted metal, it will be softened and melted. However, before it is softened, it may still generate an effective stirring. Hence, a wire may be used as “tool” to stir the pool in a certain degree before it is softened and melted. In the meantime, the wire is eventually melted becoming part of the filler metal to bridge the groove between the facing edges of the base metals. The average temperature of the weld pool will be even colder to help improve control the microstructures of the welds and reduce the distortion. Hence, the tool material may also be the filler metal.

For using a wire as the tool, this wire can enter the pool behind the torch from the same side of the base metals as the main wire that is used as the filler metal only, as discussed above. In this case, the “tool wire” must be shortened and eventually melted in the pool. The effectiveness in stirring must reduce. If the “tool wire” is added from the opposite side of the base metals as the main wire, it is possible for the wire to keep rigid in the entire pool to maximize the stirring. In such a case, the rigid wire will move toward the main wire. In this way, the rigid wire will be rapidly melted by the arc cathode. The “tool wire” is still added as part of the filler metal but the stirring effect is maximized.

As such, the material for the tool may be non-consumable as long as it would not soften or melt during stirring in the pool of melted filler metal or consumable which can be part of the filler metal. For non-consumable material, tungsten is an easy choice because its high melting point. Other materials may also be used as long as the resultant tool does not soften or melt during the stirring. Cooling has been used as an effective way to keep a material to not melt when being exposed to higher temperatures as such in gas tungsten arc welding where the arc temperature is much higher than the melting point of the tungsten electrode. A material without an ultra-high melting point may be used as the materials for consumable tool as long as appropriate measures can be taken present it from softening and melting.

### Examples of Non-Consumable Tool Shape

The use of a solid tool is to provide an effective way to move the fluid within the pool of melted metal to better heat and melt the facing edges of the base metals. This purpose can be realized even if a simple round tool is used. As such, commercial tungsten electrodes for use in GTAW process may be directly used. However, the purposed may be better served if a non-round shape is used for the tool that rotates in the pool of melted filler metal.

Examples of simple possible non-round shapes may be square, rectangular, or other polygon which all can directly and more effectively push fluid to move than a round shape. For a round shape, the fluid is moved by the friction between the tool and fluid due to the viscosity. The efficiency is much lower than that through direct push. Of course, any shapes that are non-round can directly push the fluid and are more preferable for the maximized effects of the stirring within the pool of melted filler metal to improve the heating and melting of the facing edges and polygon shapes are just examples of such non-round shapes.

The shape of the tool may be uniform along its axis. In such a case, the fluid flow generated is primarily radial. It is arguable that the temperature within the pool of the melted filler metal is also not uniform in the depth direction with the temperature at the top surface being higher. Hence, a tool shape which promote the fluid to flow downward may also be used. A shape like a tool for drilling may be an example of such a shape and can be used to improve the heating and melting of lower part of the facing edges.

### Examples of Stirring Ways

A simple way to generate a stirring within the pool of the melted filler metal is to rotate a non-consumable tool. This is often preferred because it can be easily realized. One way to realize the rotation of tool is to carry a tool by a robot. This provides an additional benefit because the robot can control and adjust the distance behind the welding torch which feeds the main wire (100 in FIG. 1).

When the tool rotates, the fluid flows in all directions. To be more effective in heating and melting the facing edges of the base metals to be joined, the tool can vibrate transversely. In such a way, the fluid flow and heat exchange due to the vibration of the tool will be primarily transverse and should be more effective to direct the hotter liquid metal to the facing edges. Also, the vibration can be easily realized by various available commercial ways. A possible way is to use a piezo-electrical actuator which can generate ultra-high frequency vibration/oscillation. Because of the use of vibration, the movement of the tool is much restricted such that cooling the tool becomes much easier.

The vibration aforementioned is transverse. It can also be both transverse and vertical. The vibration can also be easily applied to a consumable tool, a wire that is eventually melted, by vibrating the torch that carries/feeds the for stirring.

Further, the rotation and vibration of the tool aforementioned are both for a mechanical movement that serves a purpose to enhance the heat transfer in the pool to better heat and melt the facing edges of the base metals to be joined. More broadly, as along as a solid object moves in the pool, such purpose may be served. Hence, the key is a movement of the solid tool within the pool of melted filler metal, rather than the specific form of the movement.

Still further, the tool does not have to be a single. It can be a system of solid tools each of which may have their material, shape, and specific form of motion although they may be the same for all solid tools.

1. A method to utilize the heat contained within the pool of melted filler metal to help heat and melt the facing edges of base metals to be joined comprising
a metal work-piece with two facing edges forming a groove between;
a filler metal is melted by an arc;
the melted filler metal transfers into the groove forming a pool of liquid metal;
a non-consumable refractory solid object physically moves repeatedly in the pool of liquid metal.

2. In claim 1 where the work-piece consists of two separate pieces of metals and the two separate pieces are so placed that their faces to be joined together face each other with a distance forming the groove.

3. In claim 1 where the filler metal is a solid wire being continuously fed toward the work-piece and travelling longitudinally along the groove and is continuously melted by an arc.

4. In claim 1 where the arc that melts the filler wire is established between the wire and the work-piece.

5. In claim 1 where the refractory object travels behind the wire longitudinally with a relatively small distance.

6. In claim 1 where the refractory object also rotates, vibrates, or oscillates.

7. In claim 1 where the material of the refractory object is made of tungsten or tungsten alloys.

8. In claim 1 where the shape of the refractory object may be round or polygon or irregular and may be uniform or variable axially

9. A method to utilize the heat contained within the pool of melted filler metal to help heat and melt the facing edges of base metals to be joined comprising
a metal work-piece with two facing edges forming a groove between;
a first filler metal is melted by a first arc;
a second filler metal is melted by a second arc;
the melted filler metals transfer into the groove forming a pool of liquid metal;
a non-consumable solid object physically moves repeatedly in the pool of liquid metal.

10. In claim 9 where the work-piece consists of two separate pieces of metals and the two separate pieces are so placed that their faces to be joined together face each other with a distance forming the groove.

11. In claim 9 where the first filler metal is a solid wire being continuously fed toward the work-piece and travelling longitudinally along the groove and is continuously melted by an arc established between this wire and the work-piece.

12. In claim 9 where the second filler metal is a solid wire being continuously fed toward the work-piece and travelling longitudinally along the groove and is continuously melted by an arc established between this second wire and the first wire.

13. In claim 9 where the solid object is a tungsten rod rotating in the groove at a high speed and travelling behind the wires longitudinally with a relatively small distance.

14. A method to utilize the heat contained within the pool of molten filler metal to help heat and melt the facing edges of base metals to be joined comprising
a metal work-piece with two facing edges forming a groove between;
a filler metal is melted by an arc;
the melted filler metal transfers into the groove forming a pool of liquid metal;
a consumable solid object physically moves repeatedly in the pool of liquid metal.

15. In claim 14 where the work-piece consists of two separate pieces of metals and the two separate pieces are so placed that their faces to be joined together face each other with a distance forming the groove.

16. In claim 14 where the filler metal is a solid wire being continuously fed toward the work-piece and travelling longitudinally along the groove and is continuously melted by an arc.

17. In claim 14 where the arc that melts the filler wire is established between the wire and the work-piece.

18. In claim 14 where the consumable solid object is a continuously fed wire oscillating in the groove at a high speed transversely and travelling behind the wire longitudinally with a relatively small distance. The feed speed of this transversely oscillating wire will be determined such that the wire be completely melted to merge into the pool before it reaches the bottom of the groove.
